(19) United States
(12) Patent Application Publication
(10) Pub. No.: US 2025/0368018 A1
(43) Pub. Date: Dec. 4, 2025

(54) Hail Protective Cover for Vehicle

(71) Applicant: Audley Coley, Calgary (CA)

(72) Inventor: Audley Coley, Calgary (CA)

(21) Appl. No.: 18/678,063

(22) Filed: May 30, 2024

(51) Int. Cl. B60J 11/04

(52) U.S. Cl. CPC B60J 11/04

(57) ABSTRACT

A hail protective cover for a vehicle is provided. The hail protective cover is able to be deployed over a vehicle immediately preceding or during a hailstorm and allow for reentry into the vehicle while covered. The hail protective cover includes a cover sheet having one or more layers adapted to enclose a body of a vehicle when a perimeter of the cover sheet is positioned over the vehicle to form an interior volume. The cover further includes a door panel cover that is aligned to be positioned over the door portion of the vehicle when covered. The door panel cover can be fastened and unfastened at an interface that extends along an interior edge and a periphery of the door panel cover. In an open configuration, the door panel cover is unfastened from the interior edge of the cover sheet, thereby permitting selective opening of the vehicle door.

### BACKGROUND OF THE INVENTION

The present invention relates to a hail protective cover for a vehicle. More specifically, the present invention relates to hail protection cover for a vehicle that is deployable over a roof of a vehicle while keeping the door accessible.

Hailstorms can cause significant damage to vehicles, resulting in costly repairs and insurance claims. Traditional methods of protecting vehicles from hail damage, such as garages and hail blankets, have their limitations. Garages are not always available or accessible, and hail blankets can be difficult to deploy in an emergency situation. If a hailstorm is encountered while driving, the driver is left with few options. Some drivers elect to park the vehicle under an overhead highway structure such as a viaduct. Other drivers allow the hail damage to occur and file an insurance claim. In cases of extreme damage such as the destruction of a windshield, the owner may even need to rent a vehicle until the damage can be repaired.

The present invention offers a unique solution to the problem of hail damage to vehicles, providing drivers with a simple and effective way to protect their vehicles from hail damage on the road. By using this invention, drivers can avoid the costly repairs and insurance claims that often result from hail damage and can have peace of mind knowing that their vehicles are protected from the potentially destructive effects of hailstorms.

The invention is a hail protective cover for vehicles that is composed of a flexible and durable material that is transported in the vehicle and deployed quickly to the roof and upper side of the vehicle. The cover is designed to be easily deployed on the road in the event of a hailstorm, allowing drivers to quickly cover their vehicles to protect them from damage. The cover is portable and manageable with male and female fasteners, making it easy to use in an emergency situation. Additionally, the cover does not entirely enclose over the doors of the vehicle, thereby allowing the driver and others to enter and exit the vehicle.

In light of the devices disclosed in the known art, it is submitted that the present invention substantially diverges in design elements and methods from the known art and consequently it is clear that there is a need in the art for an improvement for a hail protective cover. In this regard the instant invention substantially fulfills these needs.

### SUMMARY OF THE INVENTION

In view of the foregoing disadvantages inherent in the known types of hail protective cover for vehicles now present in the known art, the present invention provides a new hail protective cover for vehicles wherein the same can be utilized for deploying over a vehicle immediately preceding or during a hailstorm.

It is an objective of the present invention to provide a hail protective cover for vehicles comprising a cover sheet for protecting the vehicle, wherein a door panel cover can be fastened and unfastened via a fastener at an interface that extends along an interior edge and a periphery of the door cover panel, thereby allowing selective opening of the vehicle door when covered.

It is another objective of the present invention to provide a hail protective cover for vehicles that is easy to use and can be quickly deployed on the road in the event of a hailstorm. The hail protective cover includes fasteners that do not require tools to install or remove making it easy to use in an emergency situation.

It is yet another objective of the present invention to provide a hail protective cover for vehicles that is superior to existing devices such as traditional hail blankets that can be difficult to deploy in an emergency situation, or garages that are not always available or accessible.

In yet another objective of the present invention, the hail protective cover allows for deployment of the hail protective cover during of immediately preceding a hailstorm and allows for the driver or passenger to reenter the vehicle after deployment.

It is therefore an object of the present invention to provide a new and improved hail protective cover for vehicles that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the hail protective cover affixed to a vehicle.

FIG. 2 shows a perspective view of an embodiment of the hail protective cover affixed to a vehicle with a door panel cover in an open configuration.

FIG. 3 shows a cross-sectional view of an embodiment of the hail protective.

### DETAILED DESCRIPTION OF THE INVENTION

Reference is made herein to the attached drawings. Like reference numerals are used throughout the drawings to depict like or similar elements of the hail protective cover for vehicles. For the purposes of presenting a brief and clear description of the present invention, the preferred embodiment will be discussed as used for deploying around a vehicle immediately preceding or during a hailstorm. The figures are intended for representative purposes only and should not be considered to be limiting in any respect.

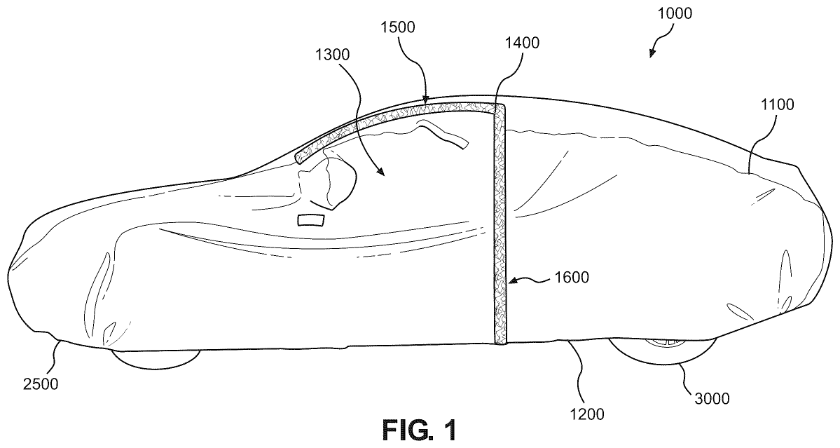

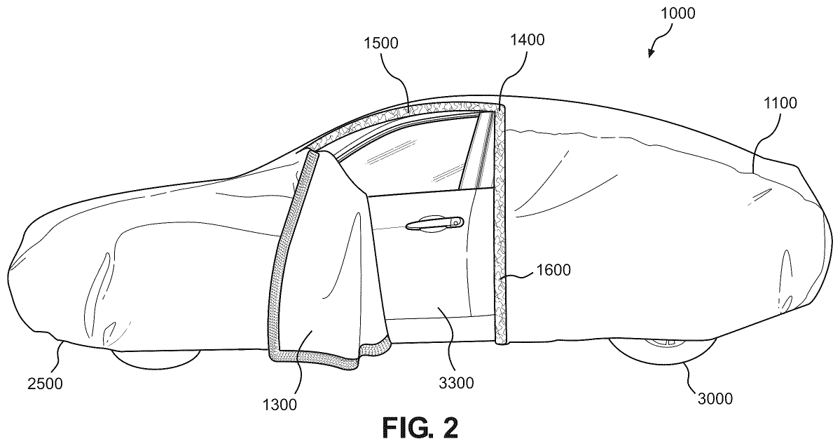

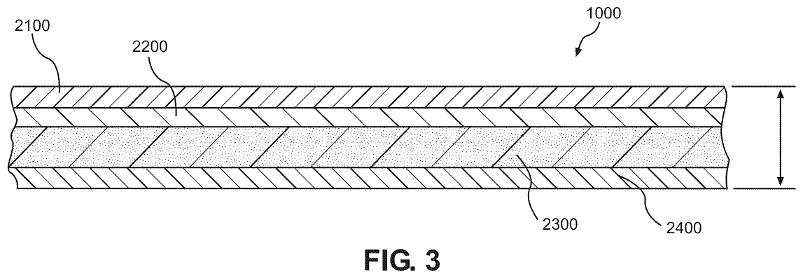

Referring now to FIGS. 1 and 2, there is shown a perspective view of an embodiment of the hail protective cover affixed to a vehicle and a perspective view of an embodiment of the hail protective cover affixed to a vehicle with a door panel cover in an open configuration, respectively. The hail protective cover 1000 for a vehicle comprises a cover sheet 1100 having one or more layers (shown in FIG. 3) adapted to enclose a body of a vehicle 3000. The cover sheet 1100 is formed as a flexible member, such as a blanket, which provides protection to the hood, roof and trunk from hail and other falling objects. Additionally, the cover sheet 1100 also provides protection to the side panels of the vehicle, including the doors. In the shown embodiment, the type of vehicle is a sedan. However, in other embodiments, the hail protective cover 1000 is sized and adapted to correspond with a variety of vehicle types, include but not limited to cars, such as hatchbacks, coupes, convertibles, trucks, such as pickup trucks, sport utility vehicles, vans, recreational vehicles, motorhomes, trailers, and tractors.

In one embodiment, the perimeter 1200 of the cover sheet 1100 includes an elastic member 2500 configured to cinch or self-tensioning around the body of the vehicle 3000. When expended and deployed to the vehicle 3000, the cover sheet 1100 forms an interior volume that is sized to cover the vehicle 3000. The cover sheet 1100 includes a door panel cover 1300 adapted to be positioned over the door portion 3300 of the vehicle 3000. The door panel cover 1300 is configured to fasten and unfasten via a fastener 1400 at an interface that extends along an interior edge 1500 and a periphery 1600 of the door cover panel 1300. The interface comprises the fastener 1400 for securing the door panel cover 1300 to the cover sheet 1100.

In one embodiment, the fastener 1400 comprises hook and loop fasteners, wherein the hook and loop fasteners comprise a male fastener on the door cover panel 1300 and a female fastener on the cover sheet 1100. The hook and loop fasteners are easy to use and can be quickly fastened and unfastened. In other embodiments, the interface comprises other fasteners 1400, including but not limited to: zipper, clips, snaps, buckles, and the like. In the shown embodiment, the interface has a width of at least two inches. In other embodiments, the width of the interface varies depending on the fastener 1400. In one embodiment, the interface is an overlapping of material from the door cover panel 1300 over the cover sheet 1100, or vise versa.

As shown in FIG. 1, the hail protective cover 1000 is in a closed configuration. The hail protective cover 1000 is adapted to transition between a closed configuration (FIG. 1) and open configuration (FIG. 2), wherein the open configuration the door panel cover 1300 is unfastened from the interior edge 1500 of the cover sheet 1100, thereby being configured to permit selective opening of the vehicle door 3300.

In one embodiment, the interior edge 1500 extends laterally along the side of the hail protective cover 1000 to permit fully opening the vehicle door. In other embodiments, the interior edge 1500 extends laterally to permit multiple doors to open, such as a rear vehicle door. The periphery 1600 of the door cover panel 1300 extends from the interior edge 1500 to the perimeter of the cover sheet 1100.

In some embodiments, the cover 1000 includes at least one transparent panel adapted to align with a window of the vehicle. In this way, if a driver is pulled over on the side of the road to await the passing of a hailstorm, he or she will have visibility through the vehicle window while the hail protective cover 1000 is deployed.

In one embodiment, the hail protective cover 1000 comprises a second door panel cover substantially similar to the first door panel cover 1300. The second door panel is positioned on the opposite side from the first door panel cover 1300 to allow for a second vehicle door to be accessible when the cover 1000 is deployed to the vehicle.

In another embodiment, the hail protective cover 1000 comprises a second door panel cover substantially similar to the first door panel cover 1300. The second door panel is positioned on the same side as the first door panel cover 1300. In this way, the front and rear doors of the vehicle are accessible when the dover is deployed to the vehicle. In one embodiment, the hail protective cover 1000 comprises multiple door panel covers that correspond to 2 or more vehicle doors.

In one embodiment, the hail protective cover 1000 comprises a variety sizes and weights. The hail protective cover 1000 is adaptable to different car makes and models, as it comes in different sizes to accommodate various sizes and shapes of vehicles. The sizes may range from compact cars to larger vehicles, including trucks and SUVs. In addition to different sizes, the hail protective cover 1000 may also vary in weight, with some embodiments having a lightweight design to enable easy deployment by a single person, while others may be heavier for added durability and protection. The different embodiments of the hail protective cover 1000 may be designed with various materials and fasteners to suit different needs and environments, and can be used in various situations, including at home or on the road during unexpected hailstorms.

Referring now to FIG. 3, there is shown a cross-sectional view of an embodiment of the hail protective cover. In the shown embodiment, the hail protective cover 1000 comprises four layers, an outer layer 2100, a first central layer 2200, a second central layer 2300, and an inner layer 2400. The hail protective cover 1000 is flexible and generally acts as a blanket. The outer layer 2100 comprises a weather resistant material to prevent moisture from penetrating through the hail protective cover 1000. The first and second central layers 2200, 2300 comprises padded foam. The foam absorbs the energy from the falling hail and prevents the vehicle from damage caused by the impact from the hail. In one embodiment, the density of the first central layer is greater than the density of the second central layer. This provides a dampening effect and spreads the force of the impact over a larger area, thereby decreasing the penetration of the hail through the layers of the hail protective cover 1000. The inner layer 2400 also comprises weather resistant material to prevent moisture from penetrating through the hail protective cover 1000. Additionally, the inner layer 2400 substantially conforms to the shape of the vehicle and is non-scratch. Together these materials provide a cushioning effect to protect the vehicle from hail and other falling objects.

In one embodiment, one or more of the layers comprises an insulated fiber material. The insulated fiber protects the vehicle from impacts as well insulates the vehicle. In one embodiment, the inner layer 2400 comprises a scratch resistant fiber. If used together, the combination of these two layers results in a hail cover that provides both scratch resistance and insulation, offering increased protection for the vehicle during hailstorms.

In one embodiment, the elastic member 2500 extends between the inner layer 2400 and the second central layer 2300. In one embodiment, the outer layer 2100 and inner layer 2400 are continuous whereby along the perimeter 1200 of the cover sheet 1100, the layers 2100, 2400 cover the perimeter and effectively completely enclose the first and second central layers 2200, 2300.

In another embodiment, the hail protective cover 1000 comprises less than four layers, such as a single layer. In other embodiments, the hail protective cover 1000 comprises more than four layers.

In one exemplary use of the hail protective cover 1000, a driver on the road encounters a hailstorm. The driver pulls over to the side of the road and removes the cover 1000 from their vehicle. The cover 1000 is positioned over and around the vehicle 3000 such that the inner layer is adjacent to the exterior of the vehicle. The elastic member 2500 is positioned around a bottom of the vehicle 3000 such that the cover 1100 remains affixed to the vehicle 3000 even in high winds. The door cover panel 1300 is in an open configuration to allow the driver to reenter the vehicle 3000. Once entered, the driver may align the fastener 1400 along the interface to transition to the closed configuration. After the storm has passed, the driver unfastens the door panel and opens the door of the vehicle while the rest of the cover 1100 is in place. The cover sheet and door panel can be easily unfastened and removed from the vehicle, leaving the vehicle in the same condition as before the hailstorm. The driver can then pack the cover back into the portable package and keep it in their vehicle for the next time they may encounter a hailstorm.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hail protective cover for a vehicle, comprising:
a cover sheet having one or more layers adapted to enclose a body of a vehicle when a perimeter of the cover sheet is positioned over the vehicle to form an interior volume;
a door panel cover extending from the coversheet adapted to be positioned over the door portion of the vehicle;
wherein the door panel cover is configured to fasten and unfasten via a fastener at an interface that extends along an interior edge and a periphery of the door panel cover;
wherein the interface comprises the fastener for securing the door panel cover to the cover sheet;
wherein the hail protective cover is adapted to transition between a closed configuration and open configuration, wherein the open configuration the door panel cover is unfastened from the interior edge of the cover sheet thereby being configured to permit selective opening of the vehicle door.

2. The hail protective cover of claim 1, wherein the fastener comprises a hook and loop fastener.

3. The hail protective cover of claim 2, wherein the fastener extends along the entire length of the interface.

4. The hail protective cover of claim 1, wherein the fastener comprises overlapping edges.

5. The hail protective cover of claim 1, wherein the sheet comprises an elastic member disposed on the perimeter of the cover sheet for self-tensioning around the vehicle.

6. The hail protective cover of claim 5, wherein the door panel cover is coextensive with the cover sheet along at least one side.

7. The hail protective cover of claim 6, wherein the interior edge of the cover sheet extends along two sides that correspond to the door of the vehicle.

8. The hail protective cover of claim 7, wherein the cover is selectively sized to cover the hood, roof, trunk, and side panels of the vehicle.

9. The hail protective cover of claim 1, wherein the cover sheet comprises:
an outer layer including a weather resistant material to prevent moisture from penetrating therethrough;
a first central layer and a second central layer, each comprising padded foam adapted to absorb energy from the falling hail and prevents damage to the vehicle caused by impact from the hail;
an inner layer including a weather resistant material to prevent moisture from penetrating therethrough.

10. The hail protective cover of claim 9, wherein cover sheet comprises an elastic member disposed on the perimeter of the cover sheet for self-tensioning around the vehicle, wherein the elastic member extends between the inner layer and the second central layer.

11. The hail protective cover of claim 9, wherein the outer layer and inner layer are continuous such that the outer layer and the inner layer extend around an edge of the cover and effectively completely enclose the first and second central layers.

12. The hail protective cover of claim 9, wherein the density of the first central layer is greater than the density of the second central layer wherein this configuration is adapted to provide a dampening effect and spreads the force of the impact over a larger area, thereby decreasing the penetration of the hail through the layers of the hail protective cover.

13. The hail protective cover of claim 9, wherein the cover sheet comprises a thickness of between. 5 inches to 2 inches.

14. The hail protective cover of claim 1, wherein the cover sheet comprises a thickness of between. 5 inches to 2 inches.

15. The hail protective cover of claim 1, wherein the cover comprises a transparent panel configured to overlap with a window of the vehicle.

16. The hail protective cover of claim 1, wherein a lower end of the cover is open when secured to the vehicle.

17. The hail protective cover of claim 1, further comprising a second door panel cover disposed on an opposing side of the door panel cover, wherein the second door panel cover is similar to the door panel cover in location and structure.

18. The hail protective cover of claim 1, further comprising a second door cover panel disposed on a same side of the door panel cover to enable a user in a front seat of a vehicle and a user of a rear seat of a vehicle to exit simultaneously.
